(19) United States
(12) Patent Application Publication
(10) Pub. No.: US 2009/0245428 A1
(43) Pub. Date: Oct. 1, 2009

(54) METHOD AND APPARATUS FOR PROCESSING COMMUNICATION SIGNAL

(76) Inventors: Shun-Pin Yang, Chang-Hua City (TW); Ho-Chi Huang, Hsinchu County (TW); Ganning Yang, Irvine, CA (US)

Correspondence Address: NORTH AMERICA INTELLECTUAL PROPERTY CORPORATION, P.O. BOX 506, MERRIFIELD, VA, 22116, US

(21) Appl. No.: 12/058,760

(22) Filed: Mar. 31, 2008

(51) Int. Cl. H04L 27/22

(52) U.S. Cl. 375/330

(57) ABSTRACT

Methods and apparatuses process a communication signal to detect a burst packet comprising an access code. The method comprises deriving a differential phase signal indicating differential phases of a first set of the access code in the communication signal, and comparing the differential phase signal with an ideal differential phase signal to calculate a frequency offset value, compensating the differential phase signal by the frequency offset value to generate a compensated differential phase signal, and detecting a burst packet transmitted via the communication signal according to the compensated differential phase signal.

### BACKGROUND

The present invention relates to signal processing in a communication system, and more particularly, to a method and apparatus of receiving a communication signal and detecting a burst packet for synchronizing packet transmission.

Wireless communication standards such as Bluetooth, transmit burst packets to its receiver, and the receiver is operated to check the packet type and detect the timing and frequency of the incoming packets. Significant frequency offset between local and remote sides is often existed, and the receiver should be capable of removing the frequency offset to prevent misreading a binary “0” as a binary “1” or vice versa. Please refer to FIG. 1, FIG. 1 is a diagram illustrating an example of frequency deviation of a GFSK modulated signal. As shown in FIG. 1, a curve CV1 illustrates the signal at the transmitter while a curve CV2 illustrates the signal received at the receiver with a DC offset in a phase domain. Please refer to FIG. 2, which is a diagram illustrating a packet format complying with the Bluetooth specification. As shown in FIG. 2, a packet 200 includes three portions: an access code 210, a header 220, and a payload 230. The access code 210 includes a 4-bit preamble 212, a 64-bit sync word 214, and a 4-bit trailer 216, and it is referenced by the receiver for the purpose of checking the received packet and the timing of the received packet. For each access code 210, the 4-bit preamble 212 has a bit pattern of either “0101” or “1010”. When the first bit of the sync word 214 is binary “1”, the preamble 212 will be “1010”; otherwise, the preamble will be “0101”. Similarly, the 4-bit trailer 216 has a bit pattern being either “0101” or “1010”, according to the last (i.e., 64th) bit of the sync word 214. The receiver and the corresponding transmitter use sync word 214 within the access code 210 to locate the packet and synchronize timing between the transmitter and receiver.

In some occasions, the packet detecting operation is estimated by in-phase baseband samples (I) and quadrature-phase baseband samples (Q) in the Cartesian domain, but the excessive multiplication complexity and the large memory size required (due to two-dimensional operations) are undesirable. Furthermore, in other packet detecting operations, the receiver extracts the phase information of received I/Q samples rather than baseband samples in the I/Q Cartesian domain; additionally, the receiver averages the received barker code of the sync word and trailer to calculate the frequency offset. However, the packet detecting operation in this manner is more sensitive to the interference and the system performance of the frequency offset estimation is degraded.

### SUMMARY

It is therefore one of the objectives of the present invention to provide a method of processing communication signals for detecting burst packets in Bluetooth technology to solve the aforementioned problem.

According to one exemplary embodiment of the present invention, a method of processing a communication signal comprises deriving a differential phase signal indicating differential phases of a first set of an access code in the communication signal, and comparing the differential phase signal with an ideal differential phase signal to calculate a frequency offset value.

According to another exemplary embodiment of the present invention, an apparatus for processing a communication signal comprises a differential phase detector, for deriving a differential phase signal indicative of differential phases of a first set of an access code in the communication signal; and a frequency offset estimator, coupled to the differential phase detector, for comparing the differential phase signal with an ideal differential phase signal to calculate a frequency offset value.

An embodiment of the communication signal processing method comprises deriving a differential phase signal indicating differential phases of a first set of an access code in the communication signal; comparing the differential phase signal with an ideal differential phase signal to calculate a frequency offset value; compensating the differential phase signal using the frequency offset value to obtain a compensated differential phase signal; and calculating a relationship between the compensated differential phase signal and a second set of the access code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an example of frequency deviation of a GFSK modulated signal.

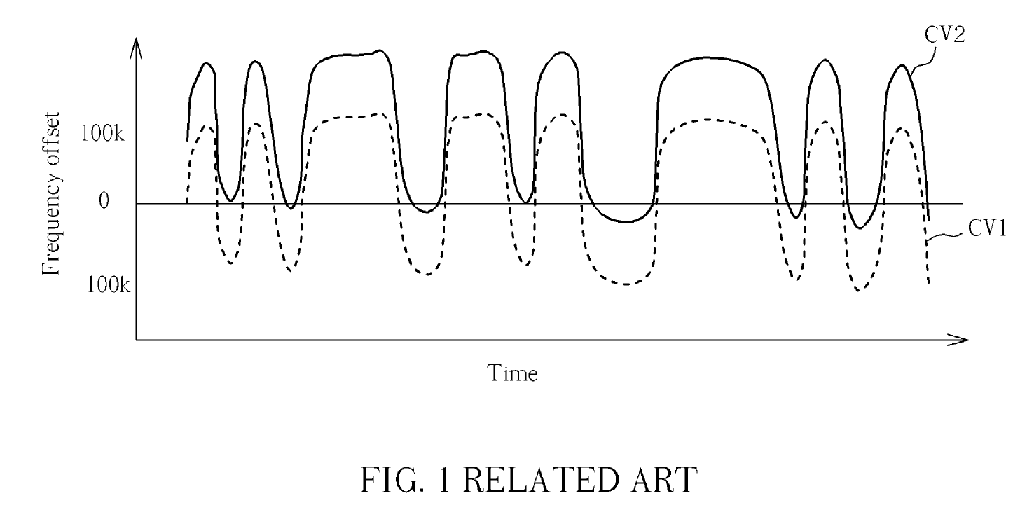

FIG. 2 is a diagram illustrating a packet format complying with the Bluetooth specification.

FIG. 3 is a simplified block diagram illustrating a receiver according to an embodiment of the present invention.

FIG. 4 illustrates a detailed diagram of a first exemplary embodiment of a sync word detector shown in FIG. 3.

FIG. 5 illustrates a diagram of an embodiment of the correlator shown in FIG. 4.

FIG. 6 illustrates a detailed diagram of a second exemplary embodiment of the sync word detector shown in FIG. 3.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

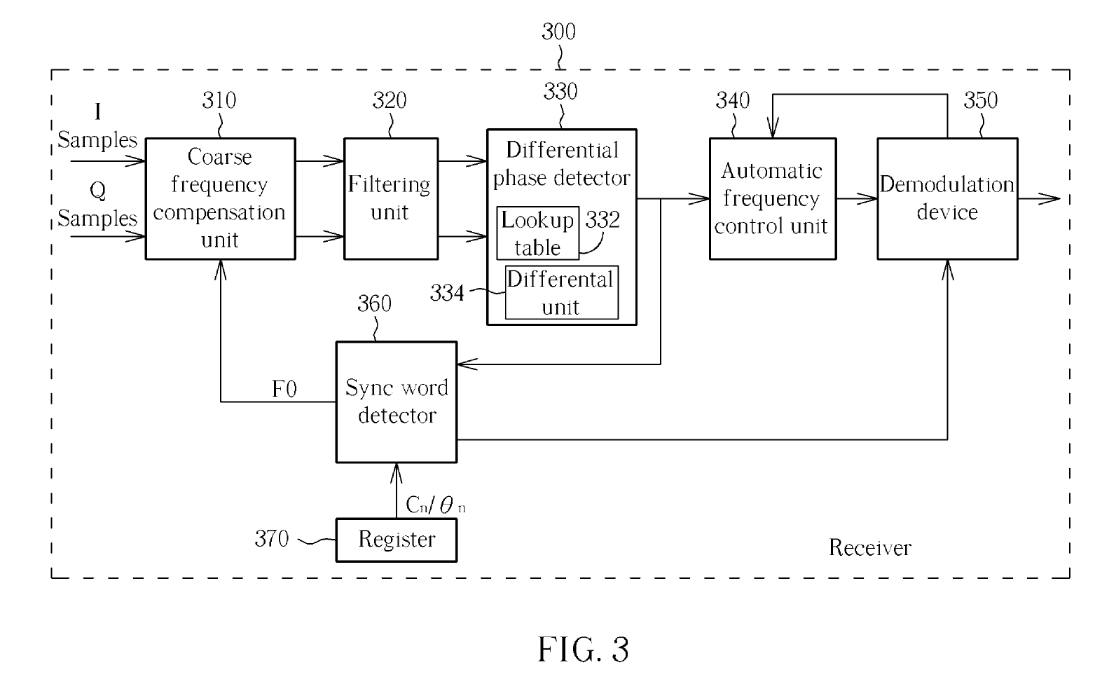

Please refer to FIG. 3. FIG. 3 is a simplified block diagram illustrating a receiver 300 according to an embodiment of the present invention. In this embodiment, the receiver 300 includes, but is not limited to, a coarse frequency compensation unit 310, a filtering unit 320, a differential phase detector 330, an automatic frequency control (AFC) unit 340, a demodulation device 350, and a sync word detector 360. In this embodiment, the receiver 300 further comprises a register 370 coupled to the sync word detector 360 for supplying a known ideal sync word Cn, and ideal differential phases θn can be derived from the ideal sync word Cn. In this embodiment, the coarse frequency compensation unit 310 is utilized for roughly removing the frequency offset existing in the in-phase baseband samples and the quadrature-phase samples of the received signal, and the filtering unit 320 coupled to the coarse frequency compensation unit 310 is for executing a filtering operation upon the in-phase baseband samples and quadrature-phase baseband samples outputted from the coarse frequency compensation unit 310.

For simplicity, in the following description, the in-phase baseband samples are represented as I samples and the quadrature-phase baseband samples are represented as corresponding Q samples. As shown in FIG. 3, the differential phase detector 330 comprises a look-up table 332 to execute an arctangent operation upon I samples and Q samples to generate phase signals accordingly. In other embodiments, devices capable of calculating arctangent values, arc tan(Q/I), can be utilized to replace the look-up table 332 in FIG. 3. In addition, the differential phase detector 330 further comprises a differential unit 334 to extract differential phase information from the phase signals (such as a sync word in the phase domain of the received packet) to obtain differential phase signals (such as a differential phase Sn of the received sync word Dn). Briefly summarized, the differential phase detector 330 extracts the phase information between an in-phase signal and a quadrature-phase signal of the communication signal to generate a phase signal, and then extracts phase difference information from the phase signal to generate the differential phase signal.

The sync word detector 360 is implemented to calculate the frequency offset value FO of the received signal and detect the appearance of a wanted sync word. Once the received signal is confirmed as wanted sync word, the frequency offset FO is further used to compensate the remaining part of the packet. For instance, when the frequency offset FO of the received packet is 65 kHz, the coarse frequency compensation unit 310 roughly removes a main portion of the frequency offset (e.g., 50 kHz), and the remaining frequency offset (e.g., 15 KHz) is set as initial frequency value in the AFC 340. Starting from the initial value, the AFC 340 keeps correcting (possibly) time-varying frequency offset throughout the end of packet. Ideally, the packet without frequency offset will be input into the demodulation unit 350 for the following demodulating process. Owing to the operations of the AFC unit 340 and the demodulation unit 350 are known to people skilled in this art; related details are therefore omitted here for brevity.

In this embodiment, the filtering unit 320 is a low-pass filter acting as a matched filter, and the arctangent operation is implemented by a look-up table 332. In addition, the known ideal differential phase θn and/or the known ideal sync word Cn are stored in the register 370. However, the implementation of the register 370 for storing the known sync word information is not meant to be a limitation of the present invention.

Roughly speaking, the sync word detector 360 of the present invention calculates the frequency offset value FO for the purpose of compensating the received differential phase signal by the frequency offset value FO to generate a compensated differential phase signal. The details as to how the sync word detector 360 in FIG. 3 works are described as follows.

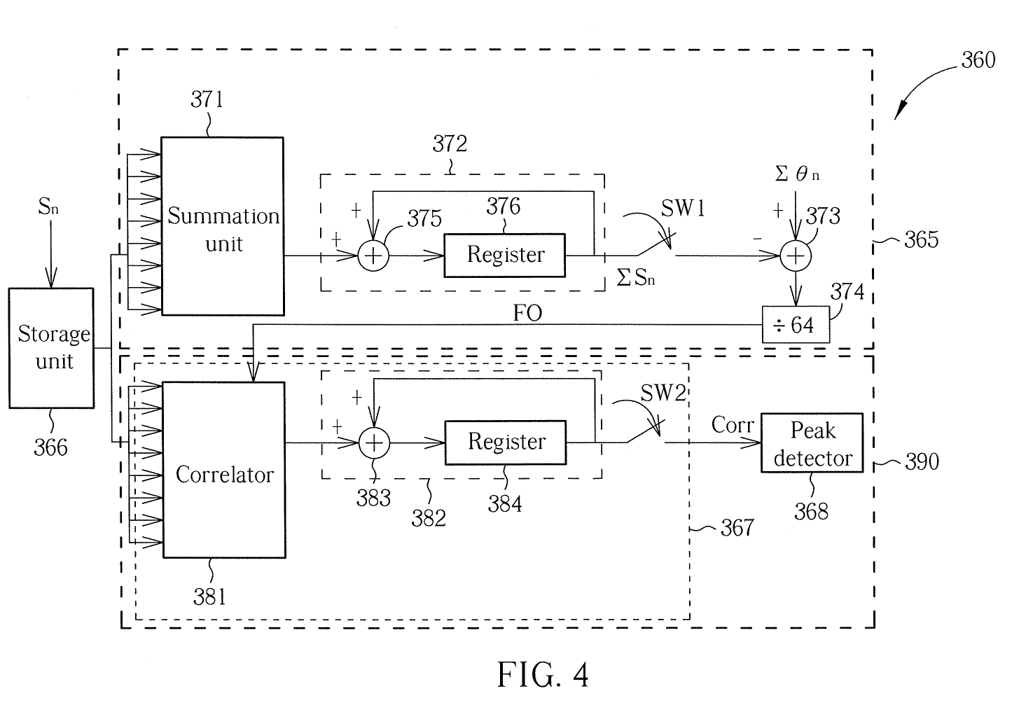

Please refer to FIG. 4 in conjunction with FIG. 3. FIG. 4 illustrates a detailed diagram of a first exemplary embodiment of the sync word detector 360 shown in FIG. 3. In this embodiment, the sync word detector 360 includes a frequency offset estimator 365, a storage unit 366, and a detecting circuit 390. The frequency offset estimator 365 estimates the frequency offset value FO according to the ideal differential phase θn of the known ideal sync word Cn and the received differential phase Sn of the received sync word Dn, and then the correlator circuit 367 in the detecting circuit 390 calculates a correlation value Corr according to the frequency offset value FO, the received differential phase Sn of the received sync word Dn, and the known ideal sync word Cn. Finally, the peak detector 368 in the detecting circuit 390 compares the correlation value Corr with a predetermined threshold value for detecting the burst packet.

As shown in FIG. 4, suppose that in the exemplary embodiment the sync word detector 360 adopts all 64 bits of a sync word in the received packet for packet detection. For calculating the frequency offset value FO, the frequency estimator 365 accesses the received differential phase signal Sn of the received sync word Dn from the storage unit 366, where the storage unit 366 can be implemented utilizing a memory (e.g., n SRAM) or a shift register. Wherein the type of the storage unit 366 is not meant to be a limitation of the present invention. In this embodiment, the frequency offset estimator 365 contains a summation unit 371, an accumulator 372 including an adder 375 and a register 376, a switch SW1, an adder 373, and a divider 374. The summation unit 371 calculates a sum of 8 samples of the received differential phase signal Sn (e.g. each differential phase sample corresponds to one bit of the access code in the packet, and is represented by 4 bits in this embodiment), and the accumulator 372 accumulates outputs of the summation unit 371. The switch SW1 in this exemplary embodiment is switched on when a summation result of 64 samples of the received differential phase signal Sn, ΣSn, is obtained, that is, when the summation unit 371 has provided eight outputs to the accumulator 372. Next, a summation result of the ideal differential phase signal Σθn (i.e.,

$${\sum }_{n = 1}^{64} θ n$$

in this exemplary embodiment) is subtracted from the summation result ΣSn. The divider 374 receives the subtraction result and outputs the frequency offset value FO by averaging the subtraction result by the number of samples (e.g. 64 samples in this embodiment). An equation for calculating the frequency offset value FO is presented below:

$$FO = \frac{1}{64} {\sum }_{n = 1}^{64} ( Sn - θ n ) =. \frac{1}{64} ( {\sum }_{n = 1}^{64} Sn - {\sum }_{n = 1}^{64} θ n ) \qquad ( 1 )$$

In some other embodiments, the frequency offset estimator 365 performs two unique averaging operations on two sets of samples of the received differential phase signal Sn. The sets of samples can have any number of samples and can be selected from any position in the packet or by any rule, for example, one set of samples belongs to bit-0 and another set belongs to bit-1, or one set of samples includes samples of a first n bits of the differential phase signal Sn and another set includes samples of a last n bits of the differential phase signal Sn. Please note that the number of bits corresponds to each set of samples is not necessary to be the same, and it is possible to select more than two sets of samples for frequency offset calculation. The frequency offset estimator 365 may derive two frequency offsets (FO) and apply the two FO to the two sets of samples for packet detection. If the two sets are samples belong to bit-0 and bit-1, a FO can be derived by subtraction the average for bit-0 from the average for bit-1.

As shown in FIG. 4, the operation for accumulating 64 samples of received differential phase signal Sn is through accumulating an accumulated result of 8 samples of the differential phase signal Sn eight times. In other words, In this exemplary embodiment the frequency offset estimator 365 accumulates 8 samples of the differential phase signal Sn each time until accumulating a summation result of 64 samples of the differential phase signal Sn.

In the first embodiment of the present invention, for detecting the received packet, the sync word detector 360 derives a correlation value Corr from the received differential phase signal Sn, the frequency offset value FO and the ideal phase signal Cn (or ideal sync word). As shown in FIG. 4, the correlator circuit 367 is configured to have a correlator 381, an accumulator 382 including an adder 383 and a register 384, and a switch SW2. Generally speaking, in the exemplary embodiment the correlator 381 generates correlation values by multiplying the ideal phase signal Cn with a difference between the received differential phase signal Sn and the frequency offset value FO, wherein the ideal phase signal Cn is accessed from the aforementioned register 370 (not shown in FIG. 4). The correlator 381 in this embodiment generates a correlation value for every eight differential phase samples, and then the accumulator 382 accumulates outputs of the correlator 381, until for example, 64 samples of the differential phase signal Sn considering the FO had been compared to the ideal phase signal Cn, to output a desired correlation value Corr. The switch SW2 is switched on when a summation result of 64 correlation values corresponding to 64 samples of the received differential phase signal Sn (i.e., Corr) is obtained. An exemplary equation for calculating the correlation value Corr is below:

$$Corr = {\sum }_{n = 1}^{64} ( Sn - FO ) \cdot Cn \qquad ( 2 )$$

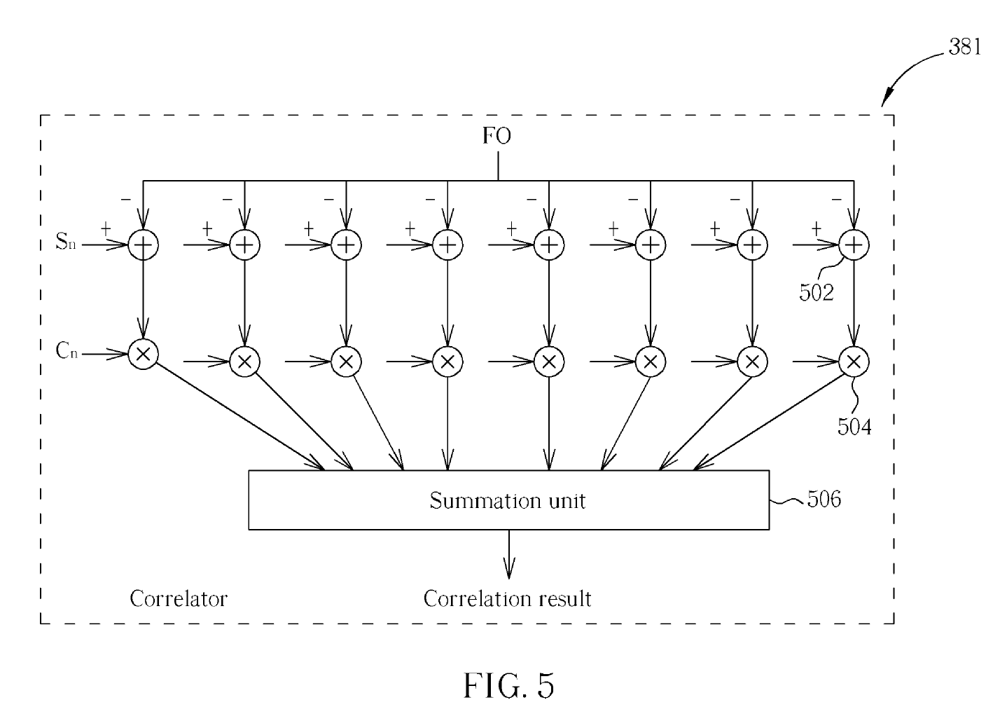

Please refer to FIG. 5 in conjunction with FIG. 4. FIG. 5 illustrates a detailed diagram of the correlator 381 shown in FIG. 4. As shown in FIG. 5, the correlator 381 includes a plurality of adders 502, a plurality of multipliers 504, and a summation unit 506. In this exemplary embodiment, the adders 502, multipliers 504, and the summation unit 506 of the correlator 381 cooperate to produce one correlation result for 8 samples of the differential phase signal Sn. Briefly summarized, the operation of the correlator 381 recovers the received differential phase signal Sn by subtracting the frequency offset value FO calculated by the frequency offset estimator 360 of FIG. 4, and then correlates (Sn-FO) with the ideal sync word Cn over the adopted 64 samples by aggregating eight correlation results as illustrated in equation (2) above.

Please refer to FIG. 4 again. The peak detector 368 then compares the correlation value Corr with a predetermined value. When the derived correlation value Corr is larger than the predetermined value, the received packet will be recognized as a valid packet, and then the following process as demodulating the data within the received packet will commence. Otherwise, the sync word detector 360 continues calculating and comparing subsequent samples of the differential phase signal for packet detection.

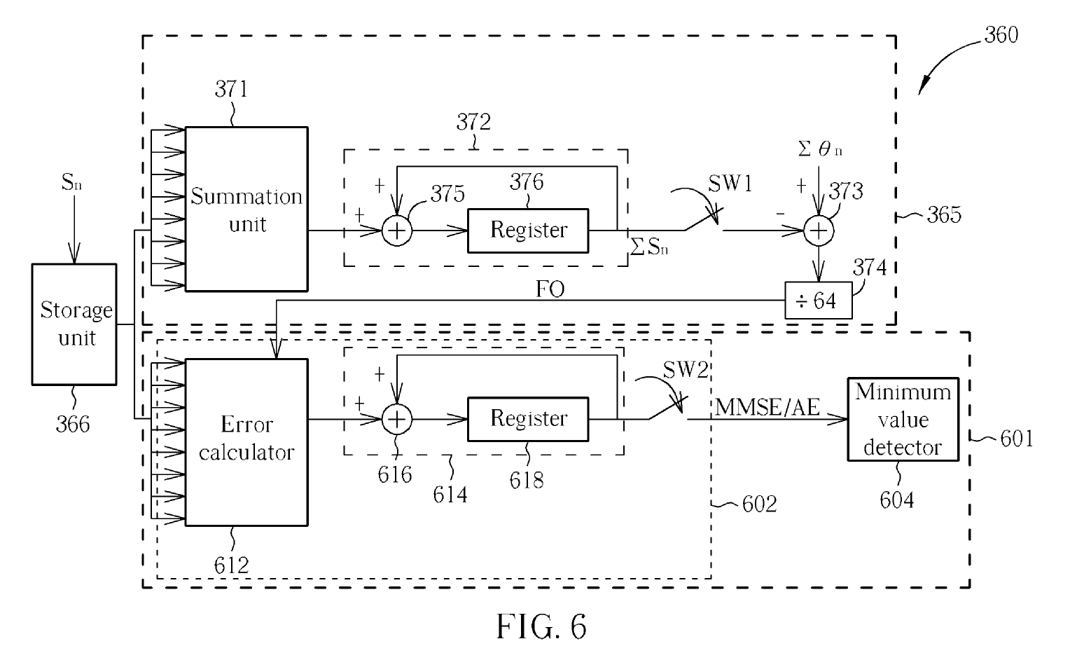

In some other embodiments of the sync word detector, packet detection can be conducted by methods rather than the aforementioned correlation comparison. Please refer to FIG. 6 in conjunction with FIG. 3. FIG. 6 illustrates a detailed diagram of a second exemplary embodiment of the sync word detector 360 shown in FIG. 3. In this embodiment, the sync word detector 360 includes a frequency offset estimator 365, a storage unit 366, and a detecting circuit 601 having an error estimator 602 and a minimum value detector 604. As the operation of the frequency offset estimator 365 has been detailed above, further description is omitted for brevity. The error estimator 602 in the detecting circuit 601 is utilized to estimate a minimum mean square error value MMSE according to the frequency offset value FO, the received differential phase signal Sn, and the ideal differential phase θn. The minimum value detector 604 in the detecting circuit 601 compares the minimum mean square error value, MMSE, with a predetermined threshold value for detecting the received packet.

Suppose that in the second embodiment the sync word detector 360 compares all 64 bits of sync word of a packet for packet detection. The frequency offset value FO may be calculated based on an average of the 64 samples that are also fed to the detecting circuit at the same time (such as the algorithm shown in equation (1)), or it may be derived based on more or less samples or even using different set of samples for calculating FO and performing packet detection. The error estimator 602 has an error calculator 612, an accumulator 614 including an adder 616 and a register 618, and a switch SW2. The operations of the switch and the accumulator in the error estimator 602 can be identical to those included in the correlator circuit 367 shown in FIG. 4 and thus descriptions are omitted for brevity. The error calculator 612 shown in FIG. 6 is configured to derive a minimum mean square error (i.e., MMSE) value, and an equation for calculating the minimum mean square error value MMSE is illustrated as below

$$MMSE = \frac{1}{64} {\sum }_{n = 1}^{64} {( ( Sn - FO ) - θ n )}^{2} \qquad ( 3 )$$

In the second embodiment shown in FIG. 6, the error calculator 612 processes eight samples at a time by subtracting the ideal differential phase θn from (Sn-FO), and then accumulates its square value (equation (3)), the accumulator then accumulates eight outputs from the error calculator 612 to get a calculated minimum mean square error value MMSE. As shown in FIG. 6, after the error estimator 602 derives the calculated minimum mean square error value MMSE, the minimum value detector 604 then compares the calculated minimum mean square error value MMSE with a predetermined value. When the calculated minimum mean square error value MMSE is smaller than the predetermined value, the received packet will be recognized as a valid packet, and the following process of demodulating the data within the received packet will commence. Otherwise, the sync word detector continues detecting for valid packet.

For applications having limited computing power, the error estimator 602 can be modified to calculate a sum of absolute error values AE rather than the minimum mean square error value MMSE. In other words, an alternative design of the error calculator 612 is devised to compute an absolute error value between θn and (Sn-FO). An equation of deriving the sum of absolute error values AE is as follows:

$$AE = {\sum }_{n = 1}^{64} / ( Sn - FO ) - θ n / \qquad ( 4 )$$

Briefly summarized, the detecting circuit 601 shown in FIG. 6 is implemented to compensate the differential phase signal by the frequency offset value to therefore generate a compensated differential phase signal (i.e., Sn-FO), and then detects a burst packet transmitted via the communication signal according to the compensated differential phase signal.

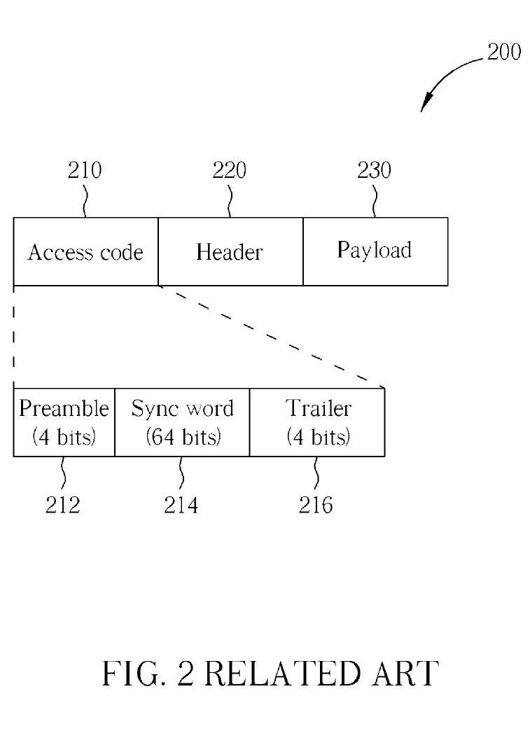

Please note that in the disclosed embodiments, the sync word detector adopts all 64 bits of the sync word in the received packet as illustrated in FIG. 2 for the packet detecting operation. However, this is not meant to be a limitation of the present invention. With an appropriate arrangement, the receiver selects a first set from the access code for deriving the frequency offset value FO, and selects a second set from the access code for the packet detecting operation. It should be noted that the first set and the second set can be different bits within the access code, or the two sets may have some bits overlapped. That is to say, the selection of the first set and the second set depends on design requirements. For instance, when the sync word detector adopts a correlator and a peak detector for packet detection, the sync word detector can use the even bits {Cn, n=0, 2, 4, 6, 8 . . . } within the sync word as the first set for deriving the frequency offset, and use the odd bits {CN, n=1, 3, 5, 7, 9 . . . } within the sync word as the second set for deriving the correlation value. This is, the present invention provides a signal processing method capable of dynamically using different bits in the access code, rather than being limited only to the use of particular bits for packet detection. Moreover, the receivers of the present invention can be very flexible in terms of using different parts and different number of bits of the access code. In some embodiments, arbitrary 1's and 0's of sync word are selected to compare with an ideal sync word, whereas conventional methods select specific bits (e.g. preamble, trailer bits) to obtain frequency offset (DC offset) by averaging same amount of 1's and 0's. In addition, the receivers of the present invention can select different packet detection manners (such as deriving a correlation value, a minimum error square value, or an absolute error value from the selected bits within the access code) for packet detection. Furthermore, the present invention provides a method in the phase domain that utilizes the differential phase of the actual received packet with a known ideal differential phase for detecting a burst packet. In conclusion, any signal processing method using one of the aforementioned schemes falls within the scope of the present invention. Those skilled in the art will readily observe that numerous modifications and alterations of the device and method may be made while retaining the teachings of the invention.

What is claimed is:

1. A method for processing a communication signal, wherein a packet in the communication signal comprises an access code, and the method comprises:
deriving a differential phase signal indicating differential phases of a first set of the access code in the communication signal; and
comparing the differential phase signal with an ideal differential phase signal to calculate a frequency offset value.

2. The method of claim 1, wherein the step of deriving the differential phase signal comprises:
extracting phase information between an in-phase signal and a quadrature-phase signal of the first set of the access code to generate a phase signal; and
extracting phase difference information from the phase signal to generate the differential phase signal.

3. The method of claim 1, wherein the first set of the access code comprises samples of a sync word in the access code.

4. The method of claim 1, further comprising:
compensating the differential phase signal by the frequency offset value to generate a compensated differential phase signal; and
detecting a burst packet carried in the communication signal according to the compensated differential phase signal.

5. The method of claim 4, wherein the step of comparing the differential phase signal with the ideal differential phase signal to calculate the frequency offset value comprises:
accumulating difference between a portion of the ideal differential phase signal and a portion of the differential phase signal, to thereby generate an accumulated value, wherein the portion of the ideal differential phase signal includes ideal differential phase values corresponding to a specific bit set selected from the access code; and
averaging the accumulated value to obtain the frequency offset value.

6. The method of claim 5, wherein the specific bit set includes samples of a first n bits of the access code.

7. The method of claim 5, wherein the specific bit set includes samples belonging to bit-0.

8. The method of claim 4, wherein the step of detecting the burst packet carried in the communication signal comprises:
deriving a correlation value according to the compensated differential phase signal and a specific bit set selected from the access code; and
comparing the correlation value with a threshold value for detecting the packet.

9. The method of claim 8, further comprising:
over-sampling the communication signal;
at each sampling instance, calculating a frequency offset value and deriving a correlation value; and
determining a sampling instance with a highest correlation value.

10. The method of claim 4, wherein the step of detecting the burst packet carried in the communication signal comprises:
accumulating square values of difference between a portion of the ideal differential phase signal and a portion of the compensated differential phase signal to thereby generate an accumulated value, wherein the portion of the ideal differential phase signal includes ideal differential phase values corresponding to a specific bit set selected from the access code;
averaging the accumulated value to generate an average value; and
comparing the average value with a threshold value for detecting the packet.

11. The method of claim 10, wherein the specific bit set includes samples belonging to bit-0.

12. The method of claim 4, wherein the step of detecting the burst packet carried in the communication signal comprises:
accumulating absolute values of difference between a portion of the ideal differential phase signal and a portion of the compensated differential phase signal to thereby generate an accumulated value, wherein the portion of the ideal differential phase signal includes ideal differential phase values corresponding to a specific bit set selected from the access code;
averaging the accumulated value to generate an average value; and
comparing the average value with a threshold value for detecting the packet.

13. An apparatus for processing a communication signal, wherein a packet in the communication signal comprises an access code, and the apparatus comprises:
a differential phase detector, for deriving a differential phase signal indicative of differential phases of a first set of the access code in the communication signal; and
a frequency offset estimator, coupled to the differential phase detector, for comparing the differential phase signal with an ideal differential phase signal to calculate a frequency offset value.

14. The apparatus of claim 13, wherein the differential phase detector extracts phase information between an in-phase signal and a quadrature-phase signal of the first set of the access code to generate a phase signal; and extracts phase difference information from the phase signal to generate the differential phase signal.

15. The apparatus of claim 13, further comprising:
a detecting circuit, for compensating the differential phase signal by the frequency offset value to generate a compensated differential phase signal; and detecting a burst packet carried in the communication signal according to the compensated differential phase signal.

16. The apparatus of claim 15, wherein the frequency offset estimator accumulates difference between a portion of the ideal differential phase signal and a portion of the differential phase signal, to thereby generate an accumulated value, where the portion of the ideal differential phase signal includes ideal differential phase values corresponding to a specific bit set selected from the access code bits; and averaging the accumulated value to obtain the frequency offset value.

17. The apparatus of claim 15, wherein the detecting circuit comprises:
a correlator circuit, for deriving a correlation value according to the compensated differential phase signal and a specific bit set selected from the access code bits; and
a detector, coupled to the correlator circuit, for comparing the correlation value with a threshold value for detecting the packet.

18. The apparatus of claim 15, wherein the detecting circuit comprises:
an error estimator, for accumulating square values of difference between a portion of the ideal differential phase signal and a portion of the compensated differential phase signal to thereby generate an accumulated value, where the first portion of the ideal differential phase signal includes ideal differential phase values corresponding to a specific bit set selected from the access code bits; and averaging the accumulated value to generate an average value; and
a detector, coupled to the error estimator, for comparing the average value with a threshold value for detecting the packet.

19. The apparatus of claim 15, wherein the detecting circuit comprises:
an error estimator, for accumulating absolute values of difference between a portion of the ideal differential phase signal and a portion of the compensated differential phase signal to thereby generate an accumulated value, where the portion of the ideal differential phase signal includes ideal differential phase values corresponding to a specific bit set selected from the access code bits; and averaging the accumulated value to generate an average value; and
a detector, coupled to the error estimator, for comparing the average value with a threshold value for detecting the packet.

20. A method for processing a communication signal, wherein a packet in the communication signal comprises an access code, and the method comprises:
deriving a differential phase signal indicating differential phases of a first set of the access code in the communication signal; comparing the differential phase signal with an ideal differential phase signal to calculate a frequency offset value;
compensating the differential phase signal using the frequency offset value to obtain a compensated differential phase signal; and
calculating a relationship between the compensated differential phase signal and a second set of the access code.

21. The method of claim 20, further comprising:
comparing the relationship with a predefined threshold for detecting the packet.

22. The method of claim 20, wherein the first and second set of the access code are the same bits.

23. The method of claim 20, wherein the relationship between the compensated differential phase signal and the second set of the access code is a correlation value.

24. The method of claim 20, wherein the relationship between the compensated differential phase signal and the second set of the access code is an error value.

25. The method of claim 20, further comprising:
over-sampling the communication signal;
at each sampling instance, calculating a frequency offset value and a relationship; and
determining a sampling instance by comparing the relationship of the sampling instances.
